(19) United States
(12) Patent Application Publication
(10) Pub. No.: US 2008/0240545 A1
(43) Pub. Date: Oct. 2, 2008

(54) Inspection Assistance System, Data Processing Equipment, and Data Processing Method

(75) Inventors: Fumiaki ENDO, Hitachinaka (JP); Tomohiro FUNAKOSHI, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Minato-ku (JP)

(21) Appl. No.: 12/056,719

(22) Filed: Mar. 27, 2008

(30) Foreign Application Priority Data
Mar. 28, 2007 (JP) 2007-083247

(51) Int. Cl. G06K 9/00

(52) U.S. Cl. 382/149

(57) ABSTRACT

To provide a device that analyzes the matching data upon determining conditions for the inspection using data processing equipment and that analyzes differences between inspection tools, thereby significantly improving and upgrading the operability of data importing and improving the usability, the present invention comprises data processing equipment connected through a communication line to a plurality of appearance inspection tools for detecting defects in a plurality of samples and a plurality of review tools for acquiring images of the defects to acquire features of the defects, wherein inspection data related to the defects in the plurality of samples from the plurality of appearance inspection tools and review data acquired by the plurality of review tools with respect to the defects are displayed on a display of the data processing equipment, and, in response to an instruction for acquiring data other than the inspection data or the review data displayed on the display, the data processing equipment acquires inspection data or review data and displays the data on the display.

### BACKGROUND OF THE INVENTION

1. Field of the Invention

The present invention relates to an appearance checking operation of products or components in the course of manufacture, and more particularly, to an inspection assistance system, data processing equipment, and a data processing method for assisting to determine the best inspection conditions and observation conditions of an inspection tool which detects particles and pattern defects on the surface of a semiconductor wafer, a photomask, a magnetic disk, a liquid crystal display which observes defects such as particles, and for assisting to analyze particles and pattern defects.

2. Background Art

In the semiconductor manufacturing process, particles and pattern defects on the wafer surface cause defective products. Therefore, particles and pattern defects (hereinafter, “appearance defects”) need to be quantified and to always monitor if there is any problem in manufacturing devices or manufacturing environments. Furthermore, the shapes of the appearance defects have to be observed to check if the appearance defects are the ones that have crucial impacts on the products.

Conventionally, such observations are visually performed by operators in the manufacturing lines. Thus, there have been problems that the defect positions of observed objects or the types of defects may vary depending on who is observing, or the defects to be observed are not constant. Recently, in order to solve these problems, techniques of ADR (Automatic Defect Review) and ADC (Automatic Defect Classification) have begun to be introduced in which a device automatically determines the sizes, shapes, types, and the like of defects by using an image processing technique. For example, a system is proposed (for example, see JP Patent Publication (Kokai) No. 10-135288A (1998), U.S. Pat. No. 6,259,960) for efficiently performing a work while lowering the load imposed on the operator when observing inspected components (for example, patterns formed on a wafer) using a review tool with an optical microscope or an SEM (Scanning Electron Microscopy).

In recent years, the defects are miniaturized along with the shrinkage of the design size of the semiconductor devices. There is a growing need for changing the inspection conditions for inspection tools that detect defects and then outputting a plurality of defects all together that are detected according to the conditions. The noise of the defect detection of the inspection tools has also become large as the inspection tools have become highly sensitive, and the number of defects detected in one inspection exceeds several tens of thousands at times. A technique has been developed for removing the noise in which the noise is eliminated by classifying the defects under inspection using an RDC (Real-Time Defect Classification) function on the inspection tools so that false detection pseudo defects such as signal noise are not transmitted to the review tools. Furthermore, in order to accurately detect defects with an inspection tool, the conditions of defect detection of the inspection tool are determined using observation results of defects in the review tool. A technology for facilitating the defect analysis is proposed in which a large amount of information outputted from inspection tools, defect IDs (identification numbers) and coordinate information outputted from observation tools, and ADR information and ADC information outputted from observation tools are organized to determine the defect detection conditions (for example, see JP Patent Publication (Kokai) No. 2001-156141A, FIG. 2).

Meanwhile, in a semiconductor manufacturing process, a plurality of highly sensitive inspection tools are included, managed, and operated. A plurality of inspection tools inspect in the same process, and thus, some devices, even among the same type of devices, exhibit different detectivity of defects. Therefore, the management of the tools is difficult as the numbers of defects or the sizes of defects vary upon inspections. At present, the data processing is conducted by matching the data one by one, and complicated analysis is performed manually.

Under the circumstances, a system for automatically matching the coordinates and organizing the defect coordinates, images, and feature data outputted from inspection tools and review tools is proposed (for example, see JP Patent Publication (Kokai) No. 2006-173589A, US 2006/0111879).

### SUMMARY OF THE INVENTION

Any desired defect information subject to coordinate matching needs to be particularly selected from a plurality of defect information imported from inspection tools when manually processing the data outputted and transmitted from these various devices using a data processing system. However, only with lot numbers, wafer IDs, dates, device names, and the numbers of detected defects, it took time to select desired defection information, or mistakes were made. At times, wrong data were read out, and unnecessary time was spent.

In view of the foregoing problems, an object of the present invention is to provide a data processing method, data processing equipment, and an inspection work assistance system as a device that analyzes matching data upon determining conditions for the inspection using data processing equipment and that analyzes differences between inspection tools, in which the operability of data importing is significantly improved and upgraded, and the usability is improved.

In order to accomplish the above object, the present invention comprises data processing equipment connected through a communication line to a plurality of appearance inspection tools for detecting defects in a plurality of samples and to a plurality of review tools for acquiring images of the defects to acquire features of the defects, wherein inspection data related to the defects in the plurality of samples from the plurality of appearance inspection tools and review data acquired by the plurality of review tools with respect to the defects are displayed on a display of the data processing equipment, and, in response to an instruction for acquiring inspection data or review data other than the inspection data or the review data displayed on the display, the data processing equipment acquires inspection data of the plurality of appearance inspection tools or review data of the plurality of review tools and displays the data on the display.

The present invention provides a device that analyzes the matching data upon determining conditions for the inspection using data processing equipment and that analyzes differences between inspection tools, thereby significantly improving and upgrading the operability of data importing and improving the usability.

### BRIEF DESCRIPTION OF THE DRAWINGS

FIG. 1 is an overall system configuration diagram of one embodiment of the present invention;

FIG. 2 is a system configuration diagram in which part of the overall configuration diagram is extracted;

FIG. 3 is a screen diagram depicting one example of defect information transmitted to data processing equipment from an appearance inspection tool and displayed on the display of the data processing equipment;

FIG. 4 depicts an RDC parameter table;

FIG. 5 is a screen diagram of one example of an image displayed on the display of the data processing equipment;

FIG. 6 is a screen diagram in which images acquired from inspection tools and review tools are displayed according to defect IDs;

FIG. 7 is an operation screen diagram used when importing data;

FIG. 8 is a screen diagram used for coordinate correction of inspection data; and

FIG. 9 is a screen diagram of the result of performing the correction calculation of magnification and angle.

### DETAILED DESCRIPTION OF THE PREFERRED EMBODIMENTS

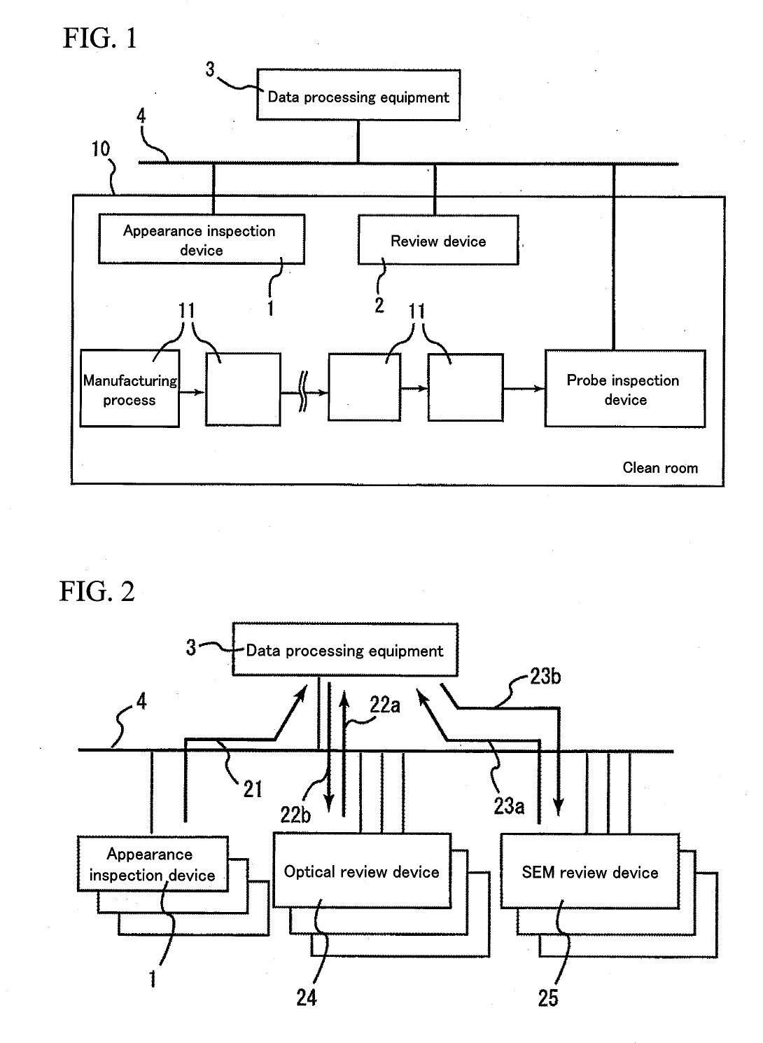

FIG. 1 is an overall system configuration diagram of one embodiment of the present invention, and FIG. 2 is a system configuration diagram in which part of the overall configuration diagram is extracted. An example of applying the present invention to a semiconductor production line is shown herein. A semiconductor manufacturing process 11 is usually in a clean room 10 in which a clean environment is maintained. In the clean room 10, an appearance inspection tool 1 for detecting appearance defects in product wafers and a review tool 2 for observing, or in other words, reviewing the appearance defects based on data transmitted from the appearance inspection tool 1 are installed. The appearance inspection tool 1 and the review tool 2 are connected through a communication line 4 to data processing equipment 3 that transfers inspections and image data. The wafers to be manufactured flow through the semiconductor manufacturing process 11 lot by lot. The appearance inspection using the appearance inspection tool 1 is performed by an operator or a conveyor carrying the wafers to the appearance inspection tool 1 after the process in which the appearance inspection is set to be performed is finished.

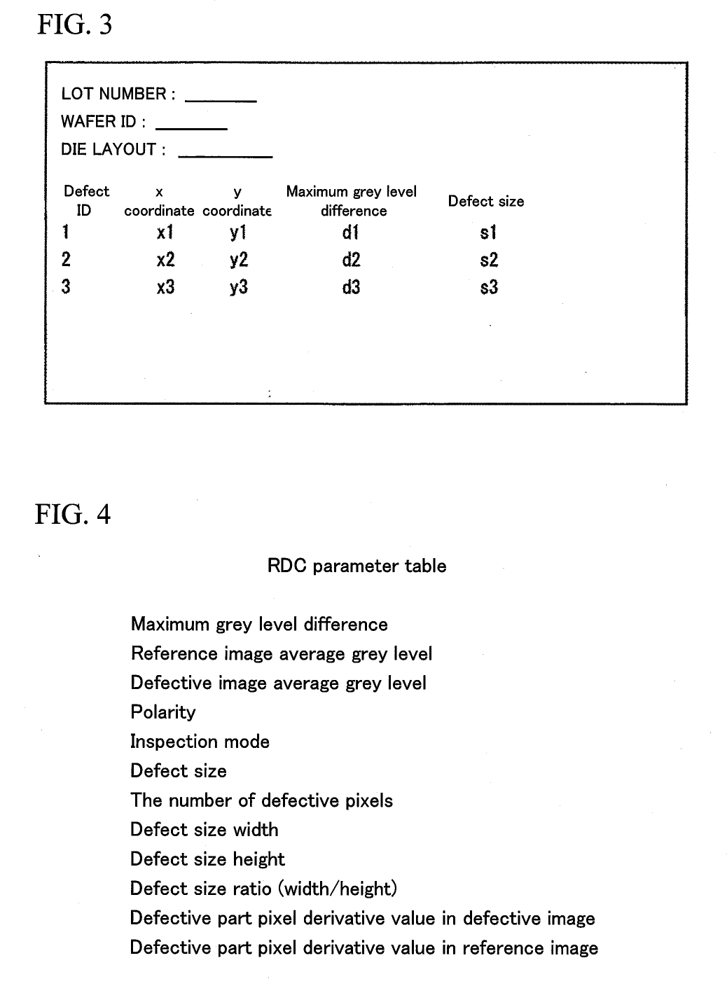

FIG. 3 is a screen diagram depicting one example of defect information 21 transmitted to the data processing equipment 3 from the appearance inspection tool 1 and displayed on the display of the data processing equipment 3, and FIG. 4 depicts an RDC parameter table.

The defect information 21, which is the result of the appearance inspection, is managed by the data processing equipment 3 using the lot number, wafer number, inspection process, and inspection date and time. The defect information 21 is constituted by lot numbers, wafer IDs, die layouts, defect IDs detected during inspection, coordinate information thereof, and the like. Although not shown, examples of other defect information 21 include defect ADR images and defect attribute information (RDC information). A possible example of the defect attribute information includes the one shown in FIG. 4. This data is transmitted as text data in a predetermined format along with other defect information. The parameters shown in FIG. 4 will be described below.

The maximum grey level difference is an absolute value of the signal of a defective part when a difference image is obtained by processing an image of the place determined as a defect and an image of its reference part. The reference image average grey level is an average value of the brightness on the reference image of the pixels determined to be the defective part, and the defective image average grey level is an average value of the brightness on the defective image of the pixels determined to be the defective part. The polarity indicates whether the defective part is brighter or darker than the reference image, and “+” indicates a bright defect while “−” indicates a dark defect. The inspection mode denotes an image comparison method used when the defect is detected, and examples include die comparison, cell comparison, and their mixed comparison. The defect size, the number of defective pixels, and the defect size ratio (width/height) denote the dimensions of the detected defect, and the unit of the width and the height is micrometer or the like, while the unit of the number of defective pixels is pixel. The defect size ratio is a parameter indicating the width/height ratio of the defect size, and for example, 1 is shown if the width and the height are the same, while 2 is shown if the width is twice as large as the height. The defective part pixel derivative value indicates a derivative value of the pixels determined to be a defect on the defective image or the reference image and indicates a degree of change in the gradation in the pixels. The value of the defective image part is referred to as a defective part pixel derivative value in defective image, while the value of the reference image part is referred to as a defective part pixel derivative value in reference image.

The wafers finished with the appearance inspection are carried to the review tool 2 for observing appearance defects, and predetermined wafers are extracted from the lots and reviewed. When reviewing, the defect information 21, i.e., lot numbers, wafer numbers, and inspection processes, of the wafers to be reviewed is acquired as key information from the data processing equipment 3. This information includes not only the defect IDs and the coordinate data, but also the ADR images obtained during inspection.

The defect information 21 outputted by the appearance inspection tool 1 is massive data, and thus, defect information 22b or 23b extracted by the data processing equipment 3 with a plurality of filter functions is transmitted through the communication line 4 to an optical review tool 24 or an SEM review tool 25. The format of the defect information 22b and 23b is generally the same as that of the defect information 21.

Images of defect detection parts are acquired by the optical review tool 24 or the SEM review tool 25 based on the extracted defect information 22b or 23b, and the images are utilized to classify the defects with the ADC function installed in each review tool. The information is transmitted through the communication line 4 to the data processing equipment 3 as ADR/ADC information 22a and 23a.

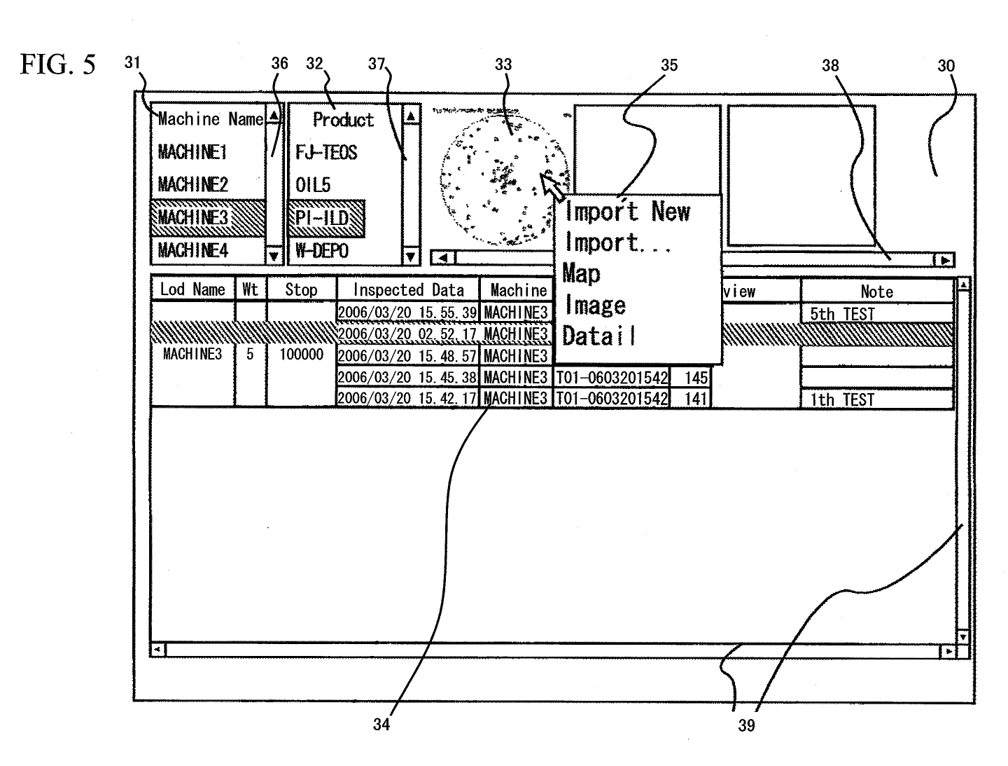

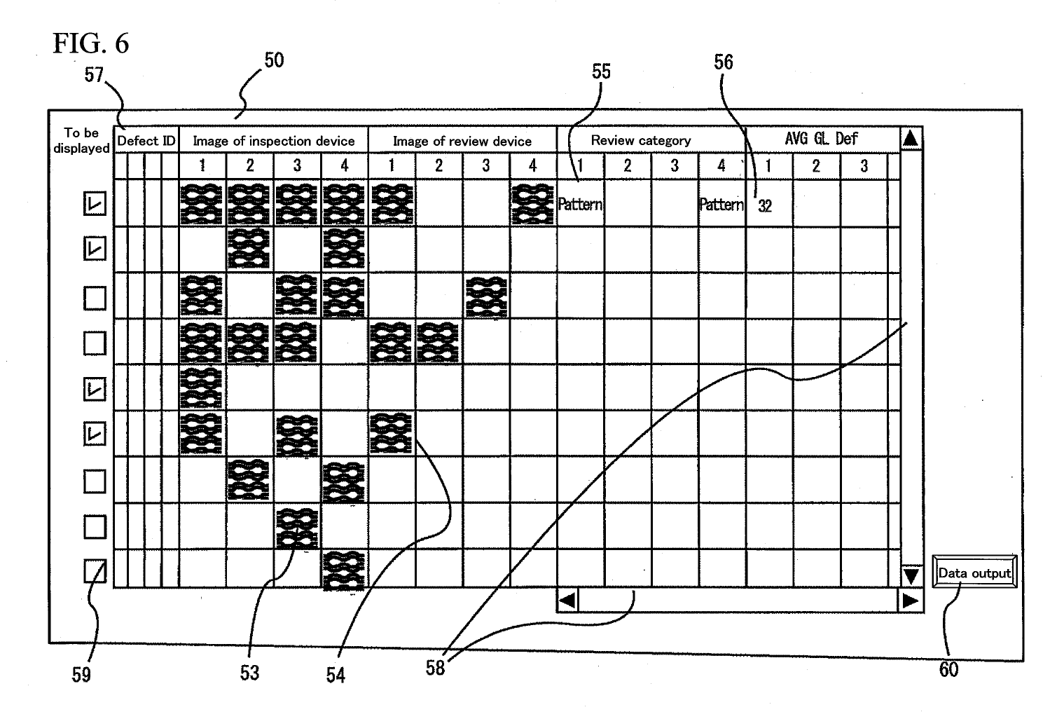

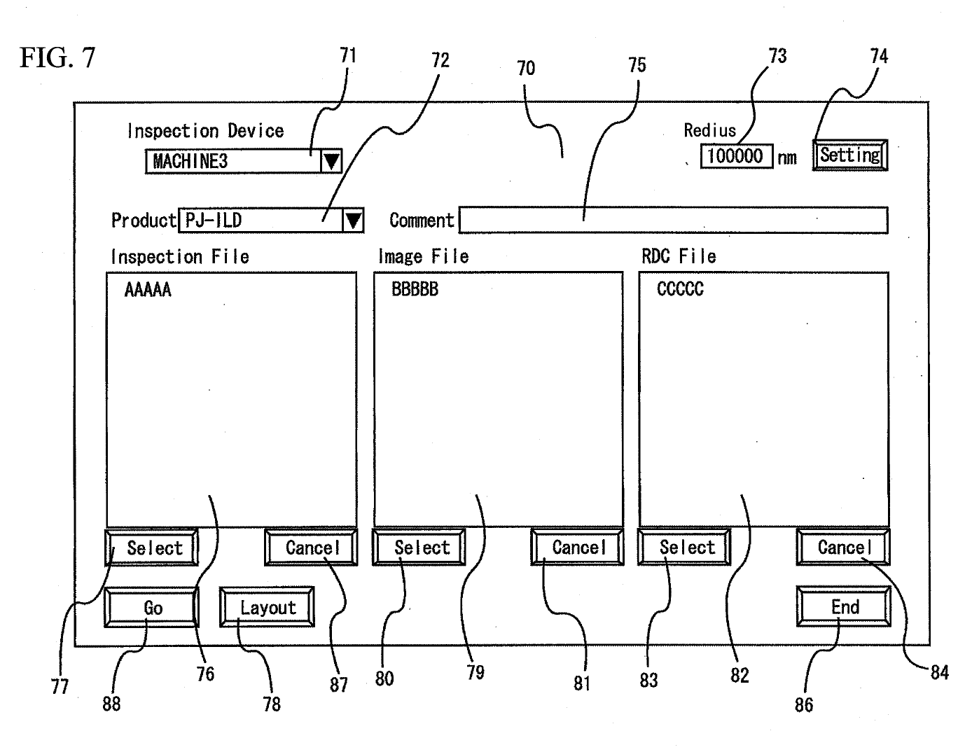

How the inspections, defect features, and image data outputted from the inspection tools are displayed and processed on the data processing equipment will now be described. An input method of the defect information of the present invention will be described with reference to FIGS. 5 to 7. FIG. 5 is a screen diagram of one example of an image displayed on the display of the data processing equipment, FIG. 6 is a screen diagram in which images acquired from the inspection tools and the review tools are displayed according to defect IDs, and FIG. 7 is an operation screen diagram used when importing data.

When an icon displayed on the display of the data processing equipment 3 is double clicked to activate the data processing equipment 3, the screen 30 shown in FIG. 5 appears on the screen. The screen 30 shown in FIG. 5 includes a device name list 31, a scroll bar 36 for the device name list, a production list 32, a scroll bar 37 for the production list, an inspection map 33, a scroll bar 38 for the inspection map, a defect information list 34, and a scroll bar 39 for the defect information list. A plurality of device names and a plurality of product names, which are data already imported into the data processing equipment 3, are displayed on the device name list 31 and the production list 32. The defect information already imported into the data processing equipment 3 is displayed as a list on the defect information list 34. If all information is not displayed on the defect information list 34, the desired part can be easily viewed using the scroll bar 39. Once the row of the inspection data in relation to the device name and the product which the operator wants to process is selected from the defect information list 34, the inspection map 33 corresponding to that is displayed, and the inspection map included in the inspection data can be checked. When the defect information list 34 or the inspection map 33 is right-clicked, a pull-down menu 35 for advancing to the next step appears. For example, when “Image” in the pull-down menu 35 is selected, a screen 50 shown in FIG. 6 is displayed.

In FIG. 6, IDs, coordinates, images acquired by the inspection tools, images acquired by the review tools, ADC results, and the like in relation to one defect is aligned and displayed in a row to facilitate matching of data of one defect to thereby facilitate change in the setting of the inspection conditions for the inspection tools and judgment of the appropriateness of the ADC results. Arranged on the screen 50 are a defect ID display section 57, images 53 acquired and transmitted from the appearance inspection tools 1, images 54 acquired and transmitted by the review tools 2, a review category section 55 that displays results in which the defects are classified by the ADC functions of the review tools, a display section 56 of defect features, and a check section 59 for selecting defects to be displayed, and the data not displayed can be displayed with a scroll bar 58. In addition to the IDs, the numbers of X and Y coordinates of defects are displayed on the defect ID display section 57. The images acquired by the appearance inspection tools 1 and the images acquired by the review tools 2 are lined and displayed side by side on the screen 50 in relation to a certain defect, thereby enabling to compare the image acquisition conditions of the same defect by abutting the images. Therefore, this can be used for modifying the image acquisition conditions of the appearance inspection tools and the review tools. When defects are selected in the check section 59 and a Data Output button 60 is pressed, the process advances to the next step.

The inspection data displayed on the inspection map 33 is data already imported into the data processing equipment 3. When importing new data that is not imported yet, as the cursor is placed on the inspection map 33 or the defect information list 34 in FIG. 5 and the right mouse button is clicked to select displayed “Import New” of the pull-down menu 35, a screen 70 shown in FIG. 7 is launched. This function is useful, for example, for importing data such as images of other review tools and ADC results in relation to a certain defect to compare on the screen 50 shown in FIG. 6, or for comparing images before and after changing the conditions on the screen 50 shown in FIG. 6 when the inspection conditions for the inspection tools are changed before reacquiring the images.

An inspection tool name section 71, a product name section 72, and a defect coordinate comparison radius section 73 in relation to the inspection data that the operator wants to import are displayed blank on the screen 70 shown in FIG. 7. In order to read out the inspection data to be inputted on the screen 30 of FIG. 5, necessary information is inputted into the inspection tool name section 71 and the product name section 72 of FIG. 7 using a pull-down list, while a radius is inputted into the defect coordinate comparison radius section 73, and a Setting button 74 is pressed for confirmation. A comment section 75 is prepared on the screen 70 to facilitate discrimination or recognition of the imported data. The operator can input any comment on the section, and the comment is displayed on the screen 30 shown in FIG. 5 after importing the data.

After inputting in each input item this way, the inspection data, i.e., coordinate data, image data, and feature data, that the operator wants to import is specified by using Drag and Drop on the screen 70 or pressing a Select button 77, 80, or 83, and the inspection data is imported into the data processing equipment by pressing a Go button 88. Each data may be specified one by one, or a plurality of files may be dragged and dropped or selected all at once. In the present embodiment, the processor of the data processing equipment automatically judges the type of the files based on extensions or inside information of the files and determines whether the files are coordinate data, image data, or feature data.

A method of importing new data into the data processing equipment and then performing the coordinate matching with the already inputted inspection data will now be described. In FIG. 5, the inspection data to be inputted and the data to be matched are displayed on the defect information list 34 by selecting the inspection tool name and the product name, and when the list or the inspection map 33 is right-clicked and “Import . . . ” is selected on the displayed pull-down menu 35, the screen 70 shown in FIG. 7 is launched. On the screen 70, in relation to the inspection data that the operator wants to import, the inspection tool name same as the inspection data that has been selected on the screen 30 is displayed on the inspection tool name section 71, the same production name is displayed on the product name section 72, and the same defect coordinate comparison radius is displayed on the defect coordinate comparison radius section 73.

The operator checks over the foregoing and modifies if any modification is needed. The operator then specifies the inspection data, i.e., coordinate data, image data, and feature data that the operator wants to import by using Drag and Drop on the screen 70 or pressing the Select button 77, 80, or 83, and the inspection data is imported into the data processing equipment by pressing the Go button 88. The result is displayed on the defect information list 34 of the screen 30 in FIG. 5.

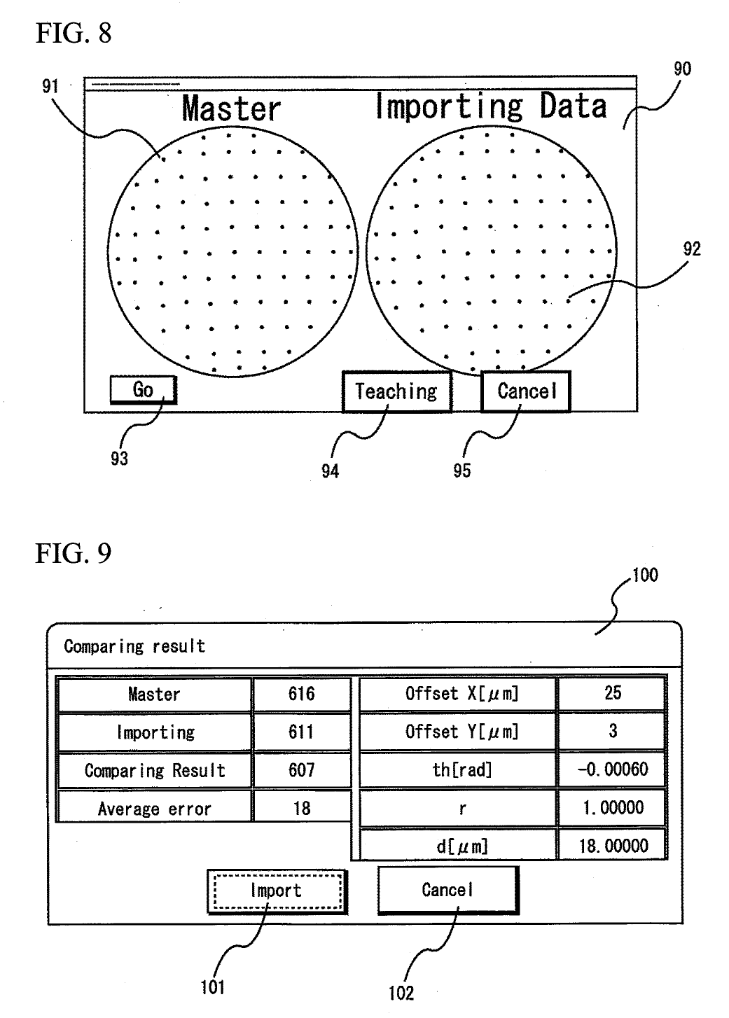

Before the above operations, when the operator notices a device-induced abnormality or a judgment error in the coordinate matching process, the operator can correct the coordinates of the inspection data with following operations. FIG. 8 is a screen diagram used for correcting the coordinates of the inspection data, and FIG. 9 is a screen diagram of the result of performing the correction calculation of magnification and angle. The data to be inputted into the data processing equipment 3 is first dragged and dropped on the screens 76, 79, 82 of FIG. 7, and when the Layout button 78 in the FIG. 7 is pressed, a screen 90 shown in FIG. 8 is launched.

A map 92 of the inspection data to be inputted and a map 91 of the inspection data already imported into the data processing equipment and subject to be matched with the inspection data to be inputted are displayed side by side on the screen 90 of FIG. 8. A Go button 93 is pressed when importing the inspection data into the data processing equipment 3 without change. If the coordinates have to be corrected, at least three dots possibly detecting the same defect can be specified from dots indicative of the locations of the defects shown in the map 91 and the map 92 and a Teaching button 94 can be pressed. The processor of the data processing equipment 3 then performs the correction calculation of magnification and angle and displays the matching and coordinate correction result on a screen 100 shown in FIG. 9. If the result is satisfactory, an Import button 101 is pressed, and the inspection data is inputted into the data processing equipment. If the result is not satisfactory, a Cancel button 102 is pressed, enabling to return to the screen 90 in FIG. 8. When finishing the operations of FIG. 8, a Cancel button 95 is pressed to return to FIG. 7.

As described, according to the present embodiment of the present invention, the defect information can be selected while looking at a defect map, a list, or the like, and the coordinate correction calculation can be performed with a manual. Therefore, the errors are reduced, and importing of inspection data is facilitated. Furthermore, the time to attain desired defect information can be reduced. As a result, the time it takes to detect desired defects and to optimize the inspection conditions can be significantly reduced.

What is claimed is:

1. An inspection assistance system comprising data processing equipment connected through a communication line to a plurality of appearance inspection tools for detecting defects in a plurality of samples and to a plurality of review tools for acquiring images of the defects to acquire features of the defects, wherein
inspection data related to the defects in the plurality of samples from the plurality of appearance inspection tools and review data acquired by the plurality of review tools with respect to the defects are displayed on a display of the data processing equipment, and
in response to an instruction for acquiring inspection data or review data other than the inspection data or the review data displayed on the display, the data processing equipment acquires inspection data of the plurality of appearance inspection tools or review data of the plurality of review tools and displays the data on the display.

2. Data processing equipment connected through a communication line to appearance inspection tools for detecting defects in samples and to review tools for acquiring images of the defects to acquire features of the defects, wherein
the following fields are displayed on the same screen: a field for displaying a device name that can identify at least one of a plurality of appearance inspection tools; a field in which product names of a plurality of samples inspected using one of the appearance inspection tools are displayed in response to one of the appearance inspection tools being specified; a map field for displaying the distribution of the extracted defects in relation to the sample in response to one of the plurality of samples being specified; and a defect information list field in which the date, the time, the number of extracted defects in the specified sample inspected by the specified appearance inspection tool are displayed with the device name of the specified appearance inspection tool and the product name of the specified sample in a tabular format, and
an image of the defects of the specified sample acquired by the specified appearance inspection tool or the review tool or the features of the defect acquired by the review tool is acquired from the specified appearance inspection tool or the review tool and displayed in response to the field displayed with the product name of the specified sample in the map field or of the defect information list field being specified.

3. The data processing equipment according to claim 2, wherein
in relation to the defects displayed on the screen, images acquired under conditions changed for the inspection using the appearance inspection tool are acquired from the appearance inspection tool and displayed.

4. A data processing method of data processing equipment connected through a communication line to appearance inspection tools for detecting defects in samples and to review tools for acquiring images of the defects to acquire features of the defects, wherein
a processor of the data processing equipment displays, on a display device, a name that can identify at least one of a plurality of appearance inspection tools, displays product names of a plurality of samples inspected using one of the appearance inspection tools in response to one of the appearance inspection tools being specified, displays on a map field the distribution of the extracted defects in relation to the sample in response to one of the plurality of samples being specified, displays the date, the time, and the number of extracted defects in the specified sample inspected by the specified appearance inspection tool as well as the device name of the specified appearance inspection tool and the product name of the specified sample on a defect information list field in a tabular format, and acquires an image of the defects of the specified sample acquired by the specified appearance inspection tool or the review tool or features of the defect acquired by the review tool from the specified appearance inspection tool or the review tool and displays in response to the field displayed with the product name of the specified sample in the map field or of the defect information list field being specified.

5. The data processing method according to claim 4, wherein
in relation to the defects displayed on the screen, images acquired under conditions changed for the inspection using the appearance inspection tool are acquired from the appearance inspection tool and displayed.
